(19) United States
(12) Patent Application Publication
(10) Pub. No.: US 2021/0107587 A1
(43) Pub. Date: Apr. 15, 2021

(54) Bicycle Handlebar Stem

(71) Applicant: Canyon Bicycles GmbH, Koblenz (DE)

(72) Inventors: Marco Anderer, Koblenz (DE); Alexander Forst, Koblenz (DE); Sebastian Wegerle, Urbar (DE)

(21) Appl. No.: 17/066,563

(22) Filed: Oct. 9, 2020

(30) Foreign Application Priority Data
Oct. 11, 2019 (DE) 20 2019 105 609.6

(51) Int. Cl. B62K 21/12

(52) U.S. Cl. CPC B62K 21/12

(57) ABSTRACT

For the connection to a bicycle handlebar, a bicycle handlebar stem comprises a receiving element at a front end or is formed integrally with the bicycle handlebar. Further, a receiving space is provided for receiving the steer tube. Using a fixing element, it is possible in particular to clampingly fix the steer tube to the bicycle handlebar stem, in particular in the receiving space. The receiving space is configured such that the steer tube can be connected to the bicycle handlebar stem at different positions without the steer tube protruding beyond an upper side with respect to the bicycle handlebar stem.

### CROSS-REFERENCE TO RELATED APPLICATION

This application claims priority to German Patent Application No. 20 2019 105 609.6 filed Oct. 11, 2019, the disclosure of which is hereby incorporated by reference in its entirety.

### BACKGROUND OF THE INVENTION

The invention relates to a bicycle handlebar stem.

A bicycle handlebar is fastened at an end of a bicycle handlebar stem which, in the mounted state, is the front end seen in the traveling direction. The fastening may be effected by means of clamping elements or the like, while an integral configuration of the bicycle handlebar stem and the bicycle handlebar is known as well. The opposite end of the bicycle handlebar stem, i.e. the end directed opposite to the traveling direction, is connected to a steer tube. For this purpose, the bicycle handlebar stem has a receiving space in which the steer tube or the upper end of the steer tube is arranged. The steer tube which is round in cross section is received in a likewise round cavity and is typically fixed in a clamping manner.

Prior to fixing the handlebar stem to the steer tube, it is further necessary to adjust the steering head bearings. This is often effected by means of a tensioning means arranged inside the steer tube and supported at the upper side of the stem. Further, it is known to provide a retaining element below the bicycle handlebar stem. The retaining element also surrounds the steer tube. Using the retaining element, it is possible to fix the bearing clearance, after adjustment thereof, by clampingly connecting the retaining element with the steer tube. This has the advantage that, after the bearing clearance has been adjusted, the bicycle handlebar stem may be removed from the steer tube and may e.g. be arranged at different heights without always requiring a readjustment of the bearing clearance when the position of the bicycle handlebar stem is changed.

For a height adjustment of the handlebar, it is known to clampingly fasten the bicycle handlebar stem to the steer tube at different heights. At a high position, distance elements, so-called spacers, surrounding the steer tube are arranged below the bicycle handlebar stem. These in particular annular spacers are thus arranged between the retaining element and the bicycle handlebar stem. If the bicycle handlebar stem is to be arranged at a lower position, the spacers are removed. The bicycle steer tube then protrudes above the bicycle handlebar stem. In this region, a cap covering the end of the bicycle steer tube is provided and/or the corresponding spacers are arranged. To avoid the bicycle steer tube from protruding above the bicycle handlebar stem, the bicycle steer tube would have to be shortened. However, a height adjustment of the bicycle handlebar stem would no longer be possible in this case.

Such a height-adjustable handlebar stem is known from US2018/0222546. The handlebar stem is clampingly connected with the steer tube, wherein one or more distance elements may be provided below the handlebar stem. At a lower position of the handlebar stem, the steer tube protrudes beyond the handlebar stem. The protruding steer tube is covered with a cap which abuts on an upper side of the handlebar stem as well as on a rear side of the handlebar stem directed towards the bicycle.

It is an object of the invention to provide a bicycle handlebar stem that allows for a simple height adjustment.

The object is achieved according to the invention with the features of claim 1.

The bicycle handlebar stem of the present invention has a receiving element at its front end, seen in the traveling direction. The receiving element serves e.g. for a clamping connection of a bicycle handlebar or another way of retaining the same. Likewise, the connection may be integral so that the bicycle handlebar stem and the bicycle handlebar are formed as one piece. The bicycle handlebar stem further comprises a receiving space for receiving a steer tube, in particular an end of the steer tube which is the upper end in the mounted state. Using a fixing element which is in particular integrated in the bicycle handlebar stem or connected to the same, it is possible to fix the steer tube to the stem, in particular in the receiving space. According to the invention, the receiving space is configured such that the steer tube can be connected to the stem at different positions by means of the fixing element. In particular, the hollow space thus has such a height in the mounting direction or the longitudinal direction of the steer tube that the steer tube can be fixed in at least two different positions without the steer tube protruding beyond the bicycle handlebar stem at a lower position. Here, it is particularly preferred that the upper and the lower possible position of the bicycle handlebar stem differ by a minimum of 10 mm, in particular at least 15 mm. In this case, the steer tube would be arranged inside the receiving space even at the lowest position and would thus not protrude beyond an upper side of the stem. An additional cover cap as known from US2018/0222546 which is arranged above the handlebar stem that transmits the force is not required at the front to cover a protruding steer tube. According to the invention, preferably no additional component is provided above the handlebar stem which transmits the force to the steer tube, and in particular no such component is required to cover a protruding steer tube.

The fixing element which is in particular integrated in the bicycle handlebar stem preferably comprises a clamping element and, in particular, is configured as a clamping element. Thus, it is possible in a simple manner to perform a clamping fixation of the upper end of the steer tube in the receiving space of the bicycle handlebar stem using clamping means such as screws. It is thus possible to connect the bicycle handlebar stem to the steer tube at different positions or different heights. Depending on the height, one or more distance elements, so-called spacers, are provided at the lower side of the bicycle handlebar stem, in particular between the bicycle handlebar stem and a retaining element for the bearings. Thus, using the bicycle handlebar stem of the present invention, it is possible in a simple manner to connect the same to the steer shaft at different positions, in particular without the top end of the steer tube protruding at the upper side of the handlebar stem.

Further, the handlebar stem may have an opening in one upper side, in particular above the receiving space, which opening can preferably be closed with a cover. For example, access to tensioning elements for the bearings can be provided through this opening. It is particularly preferred that the cover serves as an abutment element for the tensioning element, the tensioning element in particular being a screw extending into the head tube. Thus, it is possible in a simple manner to pretension the bearings by tightening the screw.

The invention further relates to a bicycle handlebar stem system. The bicycle handlebar stem system of the present invention comprises a bicycle handlebar stem as described above and in particular developed in an advantageous manner. Further, the bicycle handlebar stem system comprises a bearing retaining element adapted to be connected with the steer tube. Using such a bearing retaining element which in particular surrounds the steer tube, it is possible to fix the position of the bearings or the position of the steer tube in the head tube of the frame after the adjustment of the bearing clearance. For example, the bearing clearance can be adjusted by means of a tensioning element, as described above, which is arranged in particular inside the head tube and is supported on a cover. After the adjustment of the bearing clearance, the bearing clearance is fixed by means of the bearing retaining element. Even a loosening of the tensioning element does not cause a change in the bearing clearance, since the bearings are retained by the bearing retaining element. For a new adjustment of the bearing clearance, the bearing retaining element must be loosened. By providing such a bearing retaining element, it is possible to mount or remove the bicycle handlebar stem without a readjustment of the bearing clearance being required. Further, the bicycle handlebar stem system of the present invention comprises at least one distance element that may be arranged between the bearing retaining element and the stem. Depending on the position or the height of the bicycle handlebar stem, one or more such distance elements are provided or not.

In a particularly preferred embodiment, the distance element is configured such that it can be installed or removed with the steer tube mounted. Thus, it is possible in a preferred embodiment to set the at least one distance element on the steer tube although the steer tube is mounted inside the head tube of the frame and is in particular fixed by means of the bearing retaining element. In this respect, it is further preferred that the distance element can be set onto the steer tube from the side or vertically with respect to the steer tube. This is possible e.g. because the distance element is configured as a two-part or a multipart element. For example, a retaining element composed of two ring section-shaped elements may be provided. The two parts of the distance element, which in particular define a retaining ring, can thus be pushed laterally onto the steer tube from two different sides and then be connected with each other e.g. by means of a connecting element.

Further, it is possible that the distance element has a lateral opening so that the distance element can be pushed laterally over the steer tube already mounted. The lateral opening can be closed with an additional element or remain open. It is also possible that the distance element has a certain flexibility or elasticity so that the lateral opening can be widened at least in part in order to be able to laterally push or set the distance element over the steer tube.

The design of the bicycle handlebar stem system according to the invention in particular has the advantage that the bicycle handlebar stem does not have to be removed entirely from the steer tube to change the position of the bicycle handlebar stem on the steer tube. For a displacement of the bicycle handlebar stem in the longitudinal direction of the steer tube and a corresponding mounting or removal of the at least one distance element, it is sufficient to loosen the fixing element of the bicycle handlebar stem. This has the particular advantage which is essential to the invention that wires, Bowden cables or the like do not have to be removed and do not have to be of such a length that the bicycle handlebar stem can be taken or pulled off the steer tube completely in the upward direction.

In a further preferred embodiment, the bicycle handlebar stem comprises at least one positioning element in particular at a lower side which is directed downward or towards the bearing retaining element. It is preferred that such a positioning element is also provided at the at least one distance element and/or the bearing retaining element. This ensures an exact positioning of the individual components with respect to each other. Suitable positioning elements are in particular protrusions, indentations or the like.

For the adjustment of different positions or heights of the bicycle handlebar stem, it is possible to provide no distance elements, one or more distance elements and/or distance elements with different thicknesses.

Furthermore, it is possible that the steer tube of the bicycle frame has an outer cross section that is not round and that, as such, the at least one distance element is configured on the one hand to have an at least partially round inner part that surrounds the steer tube and, on the other hand, to have an outer part that is not round and essentially corresponds to the form of the non-round head tube of the bicycle frame.

The invention will be explained in more detail hereunder with reference to a preferred embodiment and to the accompanying drawings.

### BRIEF DESCRIPTION OF THE DRAWINGS

FIG. 1 is a schematic perspective view of a preferred embodiment of the bicycle handlebar stem system,

FIG. 2 is a schematic side view of the bicycle handlebar stem,

FIG. 3 is a schematic bottom view of the bicycle handlebar stem,

FIG. 4 is a schematic longitudinal sectional view of the bicycle handlebar stem,

FIG. 4a is a view corresponding to FIG. 4 with a steer tube in a lower fixing position,

FIG. 4b is a view corresponding to FIG. 4 with a steer tube in an upper fixing position, and

FIG. 5 is a schematic perspective view of a distance element.

### DESCRIPTION OF THE INVENTION

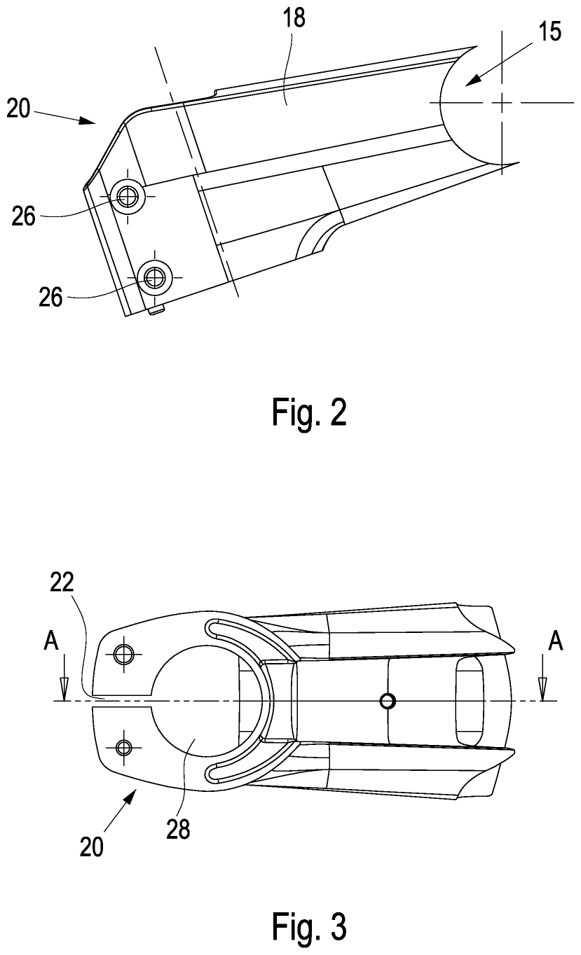

A bicycle handlebar stem 10 is connected with a bicycle handlebar 16 at its front end 14 directed in the direction of travel 12. For connection, typically by clamping, a clamping element 15 (FIG. 2), which is not illustrated in detail, is arranged in the region of the front end 14. As an alternative, it is also possible to form the bicycle handlebar stem 10 integrally with the handlebar 16.

The bicycle handlebar stem 10 has a base body 18 extending in the longitudinal direction or the traveling direction 12, said base body having a fixing element 22 at the rear end 20 opposite to the front end 14 in the traveling direction 12. In the embodiment illustrated, the fixing element 22 is configured such that the bicycle handlebar stem has a slit 24 in its rear side, and the fixing element 20 is configured as a clamping element, the clamping being achieved using clamping means which are in the form of screws 26 in the embodiment illustrated.

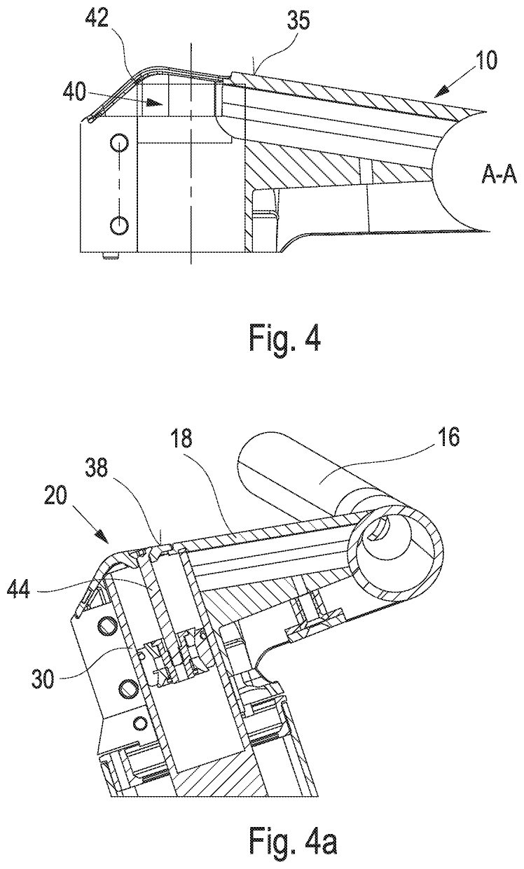

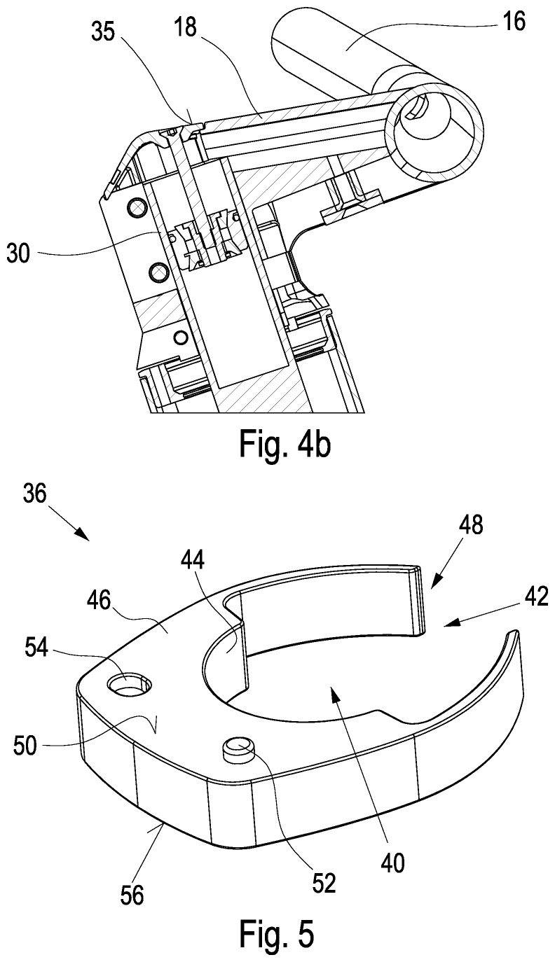

A receiving space 28 (FIG. 3) is formed within the bicycle handlebar stem. The receiving space 28 is surrounded by the fixing element 20. In the mounted state, a steer tube 30 (FIGS. 4a and 4b) is clampingly fastened at different positions by means of the fixing element 20.

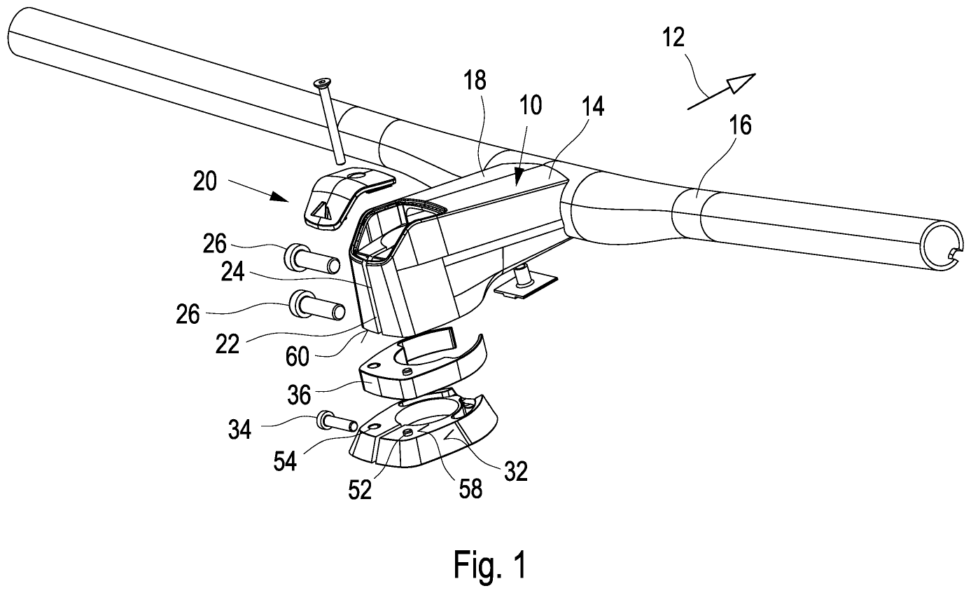

As can be seen in particular in FIG. 1, a bearing retaining element 32 is provided below the bicycle handlebar stem 10 in the mounted state. The retaining element 32 surrounds the steer tube 30 and is clampingly connected with the same by means of a clamping means 34 which again is in the form of a screw. The bearing retaining element 32 serves to fix the bearings after the adjustment of the bearing clearance. Thereby, the steer tube is mounted in the head tube of the bicycle frame, then the bearing clearance is adjusted and thereafter the bearing retaining element 32 is clampingly fixed to the steer tube. Thus, it is possible to subsequently mount, displace or remove the bicycle handlebar stem without having to readjust the bearing clearance. Here, the displacement of the bicycle handlebar stem 10 is carried out in particular to adjust different handlebar positions in the longitudinal direction of the steer tube, i.e. upward or downward.

In the embodiment illustrated, a distance element 36 (FIG. 1) is arranged between the bearing retaining element 32 and the lower side of the bicycle handlebar stem 10, when in the mounted state. Thereby, it is possible to arrange the bicycle handlebar stem 10 at an upper or higher position. For example, the bicycle handlebar stem 10 can be arranged at a lower position by removing the distance element 36. For this purpose, first the two screws 26 are loosened, the distance element 36 is removed, the bicycle handlebar stem 10 is displaced downward until the lower side of the bicycle handlebar stem rests on an upper side of the bearing retaining element 32, and thereafter the handlebar stem 10 is again clampingly fixed to the steer tube by tightening the two screws 26.

By simply arranging or removing the distance element 36, the bicycle handlebar stem 10 can thus be connected to the steer tube 30 at different positions as illustrated in particular in FIGS. 4a and 4b. In both positions, an upper end of the steer tube 30 does not protrude beyond an upper side 38 (FIG. 4) of the handlebar stem 10.

Further, it is possible to provide an opening 40 in the upper side 38 of the bicycle handlebar stem 10, which can be closed with a cover 42. By opening the cover 42, e.g. a tensioning means 44 for adjusting the bearing clearance is accessible. Thus, for mounting, prior to the fixing of the bearing retaining element and the steer tube 30, the bearing clearance is adjusted using the tensioning means 44 supported at the cover 42 in the embodiment illustrated. Once the bearing clearance is adjusted, the bearing retaining element 32 is fixed using the clamping screw 34. Thereafter, the tensioning means 44 could be loosened or even removed, since this would no longer change the bearing clearance.

The distance element 36 in particular has the shape illustrated in FIG. 5. The distance element 36 has a central circular opening 40 which in the mounted state surrounds the steer tube and in particular is in contact with the same. The opening 40 is open in a region 42 so that it can be set laterally onto the steer tube, i.e. substantially vertically with respect to a steer tube longitudinal axis.

In the embodiment illustrated the distance element 36 is configured such that it has a non-round outer cross section. For this purpose, an inner part 44 of the distance element 36, which has the opening 40, is at least partially surrounded by an outer part 46. The outer part 46 thus has a non-round outer shape which in particular corresponds substantially to a non-round configuration of a head tube of a bicycle frame. The outer part 46 also has an opening 48 in the region of the opening 42.

Further, positioning elements 52, 54 are provided on an upper side 50 of the distance element 36. Here, the positioning element 52 is formed as a pin or a peg and the positioning element 54 is formed as an annular opening. Correspondingly complementary positioning elements are provided on an opposite lower side 56 of the distance element, on an upper side 58 of the bearing retaining element 32 (FIG. 1), as well as on a lower side 60 of the bicycle handlebar stem 10.

1. A bicycle handlebar stem comprising:
a receiving element for a bicycle handlebar, provided at a front end; and
a receiving space for receiving a steer tube and a fixing element for fixing the steer tube to the bicycle handlebar stem,
wherein the receiving space is configured such that the steer tube can be connected to the bicycle handlebar stem in at least two different positions by means of the fixing element, in which positions the steer tube does not protrude beyond an upper side of the bicycle handlebar stem.

2. The bicycle handlebar stem according to claim 1, wherein a free end of the steer tube can be arranged in at least two different fixing positions inside the receiving space.

3. The bicycle handlebar stem according to claim 1, wherein the fixing element is configured as a clamping element so that the steer tube is clampingly fixed in particular by means of clamping means.

4. The bicycle handlebar stem according to claim 1, wherein the receiving space has an opening in the upper side of the bicycle handlebar stem, and wherein the opening can be closed with a cover.

5. The bicycle handlebar stem according to claim 4, wherein a tensioning means is accessible via the opening, the cover serving as an abutment element for the tensioning means.

6. The bicycle handlebar stem system comprising:
a bicycle handlebar stem according to claim 1;
a bearing retaining element adapted to be connected to the steer tube; and
a distance element which is provided between the bearing retaining element and the bicycle handlebar stem.

7. The bicycle handlebar stem system according to claim 6, wherein the distance element is configured such that it can be mounted and/or removed in a mounted state of the steer tube.

8. The bicycle handlebar stem system according to claim 6, wherein the distance element has a lateral opening for setting the same onto the steer tube from the side.

9. The bicycle handlebar stem system according to claim 6, wherein the bearing retaining element is clampingly fixed to the steer tube, in particular by means of a clamping means.

10. The bicycle handlebar stem system according to claim 6, wherein the bicycle handlebar stem and/or the distance element and/or the bearing retaining element comprise positioning elements.

11. The bicycle handlebar stem system according to claim 6, wherein for the adjustment of different positions of the bicycle handlebar stem, the distance element is provided or omitted.

12. The bicycle handlebar stem system according to claim 6, wherein for the adjustment of different positions of the bicycle handlebar stem, the distance element has different thicknesses and/or a plurality of distance elements is provided.

13. The bicycle handlebar stem system according to claim 3, wherein the clamping means comprises screws.
